(19) United States
(12) Patent Application Publication
(10) Pub. No.: US 2006/0069942 A1
(43) Pub. Date: Mar. 30, 2006

(54) Data processing system and method

(76) Inventors: Francisco Vilar Brasilerio, Campina Grande (BR); Andrey Elisio Monteiro Brito, Campina Grande (BR); Walfredo Cirne Filho, Campina Grande (BR); Livia Maria Rodrigues Sampajo, Campina Grande (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/219,536

(22) Filed: Sep. 2, 2005

(30) Foreign Application Priority Data
Sep. 4, 2004 (GB) 0419719.0

(51) Int. Cl. G06F 11/00

(52) U.S. Cl. 714/4

(57) ABSTRACT

Embodiments of the present invention relate to a data processing system and method and, in particular, to a distributed computing system and method that uses a globally distributed data structure comprising an indication of local state information associated with at least some of the processes constituting a distributed algorithm in influencing at least one of the execution and the termination of those processes.

### FIELD OF THE INVENTION

The present invention relates to a data processing system and method and, more particularly, to a distributed data processing system and method.

### BACKGROUND OF THE INVENTION

Many of the problems that need to be solved within the context of a distributed processing system can normally be specified as a set of safety and liveliness properties. Safety properties impose restrictions on the behaviour of a distributed algorithm solving any given problem and liveliness properties force the distributed algorithm to terminate eventually. There are two main sources of difficulties associated with the design of an algorithm that provides these properties. The first difficulty is associated with the lack of synchrony guarantees afforded by the underlying distributed system. The second difficulty is associated with the occurrence of failures in both processing by, and communication between, the processes executing the distributed algorithm.

As indicated above, one skilled in the art appreciates that a difficulty in designing fault-tolerant distributed algorithms or systems is related to the synchronism guarantees that the underlying systems are required to provide. Approaches to the task of designing and implementing fault-tolerant distributed algorithms based on synchronous models afford very limited portability of those algorithms which also do not scale well see, for example, F. Cristian, H. Aghili, R. Strong and D. Dolev, “Atomic broadcast: from simple message diffusion to Byzantine agreement”, Proceedings of the 15th IEEE International Symposium on Fault-Tolerant Computing, pages 200-206, June 1985 and P. Ezhilchelvan, F. Brasileiro and N. Spears, “A Timeout-Based Message Ordering Protocol for a Lightweight Software Implementation of TMR Systems”, IEEE Transactions on Computers, January 2004. On the other hand, approaches based on partially synchronous systems are inefficient. Algorithms based on such partially synchronous systems can be generally divided into two classes: namely, asymmetric and symmetric algorithms. Within asymmetric algorithm, there is a process that plays a special role see, for example, T. Chandra and S. Toueg, “Unreliable Failure Detectors for Reliable Distributed Systems”, Journal of the ACM, 34 (2), pages 225-267, March 1996 and J.-M. Hélary, M. Hurfin, A. Mostefaoui, M. Raynal and F. Tronel, “Computing Global Functions in Asynchronous Distributed Systems with Perfect Failure Detectors”, IEEE Transactions on Parallel and Distributed Systems, 11(9), pages 897-909, September 2000. One skilled in the art appreciates that this process can become a system bottleneck see, for example, L. Sampaio, F. Brasileiro, W. Cirne, J. Figueiredo, “How Bad Are Wrong Suspitions? Towards Adaptive Distributed Protocols”, Proceedings of the International Conference on Dependable Systems and Networks, June 2003. Furthermore, this special process represents a single point of failure. When it fails, costly recovery action is needed. Symmetric protocols require several message exchange rounds in order to construct a global view of the full state of the processes engaged in the distributed computation. Clearly this has undesirable traffic implications.

Typically, synchronous systems provide time bounds on both end-to-end process communication and process scheduling see, for example, “Atomic broadcast: from simple message diffusion to Byzantine agreement”, F. Cristian, H. Aghili, R Strong and D. Dolev, Proceedings of the 15th IEEE International Symposium on Fault-Tolerant Computing, pages 200-206, June 1985. This greatly simplifies the design of fault-tolerant distributed algorithms. In essence, the processes engaged in the distributed computation progress through a sequence of message exchanges that guarantee that each correct process constructs the same global state and, therefore, acts consistently. However, as is well appreciated by one skilled in the art, constructing a system that guarantees synchronous behaviour is complex. Furthermore, such complex systems do not scale well since the upper bounds for all processing and communication activities that may occur within such synchronous distributed algorithms must be known a priori.

Alternatively, it is well known that in purely asynchronous systems, that is, systems that do not have the concept of time, implementing a fault tolerant distributed algorithm is impossible see, for example, “Impossibility of Distributed Consensus with One Faulty Process”, M. J. Fischer, N. A. Lynch and M. D. Paterson, Journal of the ACM, 32(2), pages 374-382, April 1985, which is incorporated herein by reference for all purposes. However, although the majority of off-the-shelf distributed systems are not synchronous, since they do have some sort of synchronism, they are, therefore, generally classified as partially synchronous systems see, for example, “Consensus in the Presence of Partial Synchrony”, Journal of the ACM, 35 (2), pages 288-323, April 1988, C. Dwork, N. A. Lynch and L. Stockmeyer.

It will be appreciated by those skilled in the art that the abstraction of weak (or unreliable) failure detectors has been proposed to encapsulate the synchronism available in off-the-shelf systems see, for example, T. Chandra and S. Toueg, “Unreliable Failure Detectors for Reliable Distributed Systems”, Journal of the ACM, 34 (2), pages 225-267, March 1996. While using weak failure detectors enables one skilled in the art to realise fault-tolerant distributed algorithms, the resulting algorithms are complex and inefficient. Furthermore, such algorithms that are based on weak failure detectors have limited resilience as compared to algorithms based on strong failure detectors, which can only be implemented in synchronous systems. Recently, however, strong failure detector implementations have been proposed for off-the-shelf systems that rely on a hybrid architecture. The hybrid architecture encompasses the conventional partially synchronous (payload) system and a synchronous subsystem that implements the service of a perfect failure detector see, for example, P. Verissimo and A. Casimiro, “The Timely Computing Base Model and Architecture”, IEEE Transactions on Computers-Special Issue on Asynchronous Real-time Systems, 51(8), August 2002. However, algorithms that are based on strong failure detectors are still complex and execute inefficiently in runs for which a failure occurs see, for example, T. Chandra and S. Toueg, “Unreliable Failure Detectors for Reliable Distributed Systems”, Journal of the ACM, 34 (2), pages 225-267, March 1996, J.-M. Hélary, M. Hurfin, A. Mostefaoui, M. Raynal and F. Tronel, “Computing Global Functions in Asynchronous Distributed Systems with Perfect Failure Detectors”, IEEE Transactions on Parallel and Distributed Systems, 11(9), pages 897-909, September 2000 and Marcos K. Aguilera, Gérard Le Lann and Sam Toueg, “On the Impact of Fast Failure Detectors in Real-Time Fault-Tolerant Systems”, 16 International Symposium on Distributed Computing, pages 354-369, October 2002.

Although failures in any distributed computing system are unavoidable, it is desirable to be able to accommodate any such failures to some degree. It will be appreciated by those skilled in the art that detecting failures is a basic step towards being able to tolerate them and, depending on the system, the detection can range from being a trivial task to a virtually impossible endeavour. In synchronous systems there are known bounds on communication and processing delays. Therefore, detecting failures in synchronous systems is a relatively straightforward task Each time a response (or action) is not obtained within a known time delay, a failure is deemed to have occurred. On the other hand, however, in asynchronous systems neither communication nor processing delays are bound. Therefore, it is impossible to distinguish a very slow process from a crashed process see, for example, “Impossibility of Distributed Consensus with One Faulty Process”, M. J. Fischer, N. A. Lynch and M. D. Paterson, Journal of the ACM, 32(2), pages 374-382, April 1985.

One skilled in the art appreciates that failure detection is needed to solve even the most basic problems of distributed systems such as, for example, the consensus problem, which is otherwise known as the agreement problem. Furthermore, most practical distributed computer systems are not synchronous. However, practical distributed systems are also not completely asynchronous. Practical systems present some level of synchronism, which synchronism may be located in different parts of the system such as, for example, a synchronised global clock, a network channel that preserves ordering of messages or a known bound on processing delays. Therefore, to circumvent the impossibility of failure detection in asynchronous systems, various intermediate models have been proposed between the completely synchronous model and the completely asynchronous model see, for example, Chandra, T., Toueg, S.: “Unreliable failure detectors for reliable distributed systems”, Journal of the ACM 43 (1996) 225-267, Cristian, F., Fetzer, C.: “The Timed Asynchronous Distributed System Model”, IEEE Transactions on Parallel and Distributed Systems, 10(6), pp. June 1999 and Dwork, C., Lynch, N. A., Stockmeyer, L.: “Consensus in the Presence of Partial Synchrony”, Journal of the ACM, 35(2): 288-232, April 1988.

One of the most well-known models consisting in augmenting the asynchronous system with an unreliable failure detector is disclosed in Chandra, T., Toueg, S.: “Unreliable failure detectors for reliable distributed systems”, Journal of the ACM 43 (1996) 225-267. This unreliable failure detector encapsulates the synchronism of the system and can be used to solve basic problems in distributed systems. It is well known within the art that there are a number of different classes of failure detectors. The class that encapsulates the minimum synchronism to solve consensus is named ⋄S. A failure detector that satisfies the ⋄S properties may make mistakes in suspecting processes that have not crashed. Nevertheless, the information it offers is sufficient to allow deterministic solutions to the consensus problem when a majority of nodes in the system remain correct

However, there are many problems that are significantly more complex than the consensus problem, which do not tolerate wrong suspicions see, for example, Fetzer, C.: “Perfect Failure Detection in Timed Asynchronous Systems”, IEEE Transactions on Computers, 52, February 2003. Furthermore, better performance can usually be achieved when wrong suspicions do not need to be considered. Among the proposed classes of failure detectors, the class P (of Perfect) is the strongest class. Perfect failure detectors suspect all nodes that have crashed and do not suspect a node that has not crashed. One skilled in the art appreciates the notion of failure suspicion as enabling one process to suspect that another process has failed.

However, implementing a perfect failure detector requires a completely synchronous system see, for example, Larrea, M., Fernandez, A., Arvalo, S.: “On the Impossibility of Implementing Perpetual Failure Detectors in Partially Synchronous Systems”, Brief Announcements 15 International Symposium on Distributed Computing (DISC 2001), October 2001. To weaken or relax this requirement, several approaches have been proposed see, for example, Fetzer, C.: “Perfect Failure Detection in Timed Asynchronous Systems”, IEEE Transactions on Computers, 52, February 2003 and P. Verissimo and A. Casimiro, “The Timely Computing Base Model and Architecture”, IEEE Transactions On Computers-Special Issue On Asynchronous Real-Time Systems, 51(8), August 2002. The essence of these approaches is that they assume that only a small portion of the system behaves synchronously and implement the perfect failure detector in relation to this small portion, that is, in relation to the portion of the system that behaves synchronously. More recently, the idea of wormholes has been proposed see, for example, Verissimo, P., Casimiro, A.: “The Timely Computing Base Model and Architecture”, Transactions on Computers—Special Issue on Asynchronous Real-Time Systems 51 (2002). The idea of wormholes represents a more general approach that consists of a part of the system that behaves synchronously and which has access to a synchronous communication channel. The wormhole is intended to send messages with bounded delays, which will allow better progress (in terms of either efficiency or termination) in the asynchronous protocols running in the asynchronous part of the system. However, the TCB model does not sufficiently describe the implementation of a crucial point in the design of a hybrid system, that is, a system that has an asynchronous part and a synchronous part, which is how to interface these two parts without compromising the functioning of each other. Failing to address the interface issue (i) allows the asynchronous system to overload the synchronous system and (ii) creates the risk of loss of information produced by the synchronous system that is destined for the asynchronous system.

It is an object of embodiments of the present invention to at least mitigate some of the problems of the prior art.

### SUMMARY OF INVENTION

Accordingly, a first aspect of embodiments of the present invention provides an asynchronous distributed system for executing a distributed algorithm, the distributed system comprising a plurality of processing nodes each running a respective process associated with the distributed algorithm; and a synchronous communication system for exchanging bounded messages between selected processes within bounded time periods; the synchronous communication system comprising means to distribute global digest data relating to the local states of each, or selected, processors of the plurality of processes.

It can be appreciated that the GSDP is advantageously equivalent to an external observer that is queried in a synchronised manner. Embodiments provide a framework to design and implement fault-tolerant distributed algorithms that are as simple as those based on synchronous systems but yet require only the infrastructure needed to implement perfect failure detectors, that is, a synchronous subsystem. Furthermore, since the GSDs are smaller than the information exchanged by algorithms for synchronous systems, algorithms based on embodiments of the present invention, that is, upon the GSDP, are likely to be even more efficient than their synchronous counterparts.

In preferred embodiments, the selected processes are correct processes.

It will be appreciated that embodiments of the present invention provide an alternative way to design and implement fault-tolerant distributed protocols. In comparison with existing approaches embodiments of the present invention exhibit both efficiency and simplicity.

Embodiments advantageously speed up the performance of distributed protocols because they can terminate as soon as a minimal condition required to solve the problem is satisfied. Embodiments of the present invention preferably detect this condition as soon as the processes receive a GSD encapsulating that condition.

It is thought, without wishing to be bound by any particular theory, that since the new GSDs are formed soon after associated or relevant events and that they are conveyed through fast communication channels, it is likely that algorithms implemented using a GSDP can be implemented to run relatively quickly.

Furthermore, embodiments of the present invention advantageously remove the need to construct a common global knowledge source via the exchange of messages throughout the distributed system. It will be appreciated by one skilled in the art that this substantially reduces message traffic, which can directly impact the performance of the algorithm, that is, the performance of the distributed algorithm or system.

Embodiments preferably structure the distributed algorithm as a sequence of synchronisation steps. It will be appreciated by those skilled in the art that this greatly simplifies the distributed algorithm since, firstly, message exchanges are reduced to a single round of message exchanges in which each process may send a message to the other processes, and, secondly, at the core of each algorithm is a state machine, which greatly simplifies the task of proving the correctness of the distributed algorithm; the latter being a key issue for fault-tolerant algorithms.

It will be appreciated that embodiments of the present invention allow an investigation into, or at least provide, the, preferably, minimal, synchrony guarantees that a distributed system should provide to allow fault-tolerant solutions to fundamental distributed problems such as, for example, consensus.

### A BRIEF DESCRIPTION OF THE DRAWINGS

Embodiments of the present invention will now be described, by way of example only, with reference to the accompanying drawings in which:

FIG. 1 shows a distributed computing system according to an embodiment;

FIG. 2 illustrates a schematic representation of the communication between processes and a Global Services Digest Provider according to an embodiment;

FIG. 3 depicts a synchronous communication device according to an embodiment;

FIG. 4 shows the services supported by the Global Services Digest Provider according to an embodiment;

FIG. 5 illustrates a state diagram of a state machine associated with a simple consensus algorithm; and

FIG. 6 depicts a state diagram of a message efficient consensus algorithm

### DETAILED DESCRIPTION OF THE PREFERRED EMBODIMENTS

Before proceeding with a detailed description of the preferred embodiments of the present invention, a number of definitions are presented.

“Asynchronous system” is defined as a system in which or for which there are no bounds relating to communication or processing delays.

“Synchronous system” is defined as a system in which there are bounds for both communication and processing delays,

“FD” is a failure detector.

A “Wormhole” is a synchronous subsystem via which limited amounts of data can be sent with bounded end-to-end delivery delays.

“System Model” refers to a System model such as the one described in “Impossibility of Distributed Consensus with One Faulty Process”, M. J. Fischer, N. A. Lynch and M. D. Paterson, Journal of the ACM, 32(2), pages 374-382, April 1985. It comprises a finite set Π of n processes, n>1, namely, Π={p₁, . . . , pₙ}. A process can fail by crashing, i.e., by prematurely halting, and a crashed process does not recover. A process behaves correctly (i.e. according to its specification) until it (possibly) crashes. At most f processes, f<n, may crash

Processes communicate with each other by message passing through reliable communication channels: there is no message creation, that is, messages other then those generated by the execution of the algorithm are not carried by the channel; in particular, messages are not “spontaneously” generated by the channel, alteration, duplication or loss. Processes are completely connected. Thus a process pᵢ may: (1) send a message to other processes; (2) a receive message sent by another process; (3) perform some local computation; or (4) crash. There are assumptions neither on the relative speed of processes nor on message transfer delays, which, as is appreciated by those skilled in the art, characterises an asynchronous system.

“Global State Digests” The progress of a distributed computation is governed by the local computations that each process performs, which, in turn, are influenced by the way each process perceives the computations that have been executed at remote, that is, other processes. A Global State Digests (GSD) is a summarised description of the concurrent events that happened within the system during a particular time interval, including, preferably, an indication of the processes that have crashed. A GSD comprises at least a detection_vector which is a status vector with n bits, in which element i represents the operational status of process pᵢ (1 if pᵢ is correct, and 0 otherwise). Additionally, a GSD preferably contains a reception_matrix which is an n×n matrix in which the element [i,j] represents the perception by pᵢ of pⱼ's processing. The elements of the matrix are initially set to 0 but changed to 1 if a message has been received, that is, the reception_matrix indicates which processes have received which messages; if pᵢ receives a message from pⱼ, then reception_matrix[i,j]=1. It will be appreciated that, in any event, the number of bits constituting a GSD is bounded. In essence, a GSD conveys state information of a process or processes.

“Distributed algorithm” is considered to be an algorithm that is structured as a sequence of one or more synchronisation steps. During the execution of the synchronisation steps, a finite sequence of GSDs is generated. These GSDs encapsulate the events that happened at each process during a particular time interval. A differentiation can be made between two special types of GSDs, that is, GSDs that encapsulate a synchronisation condition, denoted SC-GSD, and those that encapsulate a termination condition, denoted TC-GSD. A SC-GSD defines a state in which all processes know how they must finish the synchronisation step. A TC-GSD for a process pᵢ contains information that allows pᵢ to infer that it may finish its execution of the synchronisation step in such a way that the safety and liveliness properties of the distributed algorithm are preserved. It should be noted that the formation of a GSD is defined by its data structure as well as how this data structure is updated according to the events that happened during a particular execution of the synchronisation step. GSDs for a particular synchronisation step are said to be well formed if, for every execution of the synchronisation step, the following properties are satisfied:
Synchronisation—at least one SC-GSD is formed such that this property guarantees that all correct processes will reach a point in the execution of an algorithm step such that they know the outcome of the step;
Termination—at least one TC-GSD is formed for every process that does not crash before or during the execution of the step, which guarantees that all correct processes finish the execution of an algorithm step and are able to proceed to the next step, if there is such a step;
Ordered formation—no TC-GSD can be formed before a SC-GSD is formed; and
Monotonicity—if a TC-GSD is formed for a process pᵢ, then every subsequent GSD formed is also a TC-GSD for pᵢ.

“Global State Digest Provider” is a service that is able to provide processes with an ordered sequence of GSDs. More formally, if GSDs are well formed, a GSDP provides the following properties for every execution of any synchronisation step of a distributed algorithm:
step synchronisation: eventually every correct process is delivered at least one SC-GSD;
agreement: if a process is delivered an SC-GSD sc, then every other process that is delivered a SC-GSD is also delivered sc;
ordered delivery: let gsd₁ and gsd₂ be two GSDs, formed in that order; if both gsd₁ and gsd₂ are ever delivered to some process, then gsd₁ is delivered before gsd₂. It will be appreciated by those skilled in the art that ordered delivery is important to guarantee safety. In other words, it guarantees that every correct process takes the same decisions while executing the algorithm. It will be appreciated that if GSDs were delivered in different orders to different processes, the processes may take inconsistent actions. For example, take the GSDs used in the consensus protocol, and assume that an action is taken based on the identity of the first process that receives all the messages that have been sent, which will happen when there is at least one line in the reception_matrix with all elements set to 1; now assume that if there are two or more of such lines, the algorithm chooses the smallest identity among those that have received all messages; if gsd₁ carries the information that pₖ has received all messages and gsd₂ carries the information that both pₖ and pⱼ, j<k, have received all messages, then a process that is delivered gsd₁ first takes an action considering the identity of pₖ, while another process that is delivered gsd₂ first takes an action considering the identity of pⱼ; and
   step termination: eventually the GSDP delivers at least one TC-GSD to every correct process.

Furthermore, the GSDP also provides for every execution of any synchronisation step of a distributed algorithm the strong completeness and the strong accuracy properties required of a perfect failure detector, which are as stated below
strong completeness: if some process pᵢ crashes, then every process pⱼ is eventually delivered a GSD that indicates failure; and
strong accuracy: if any GSD indicates that pᵢ has crashed, then pᵢ has indeed crashed.

In preferred embodiments, the design of a distributed algorithm supported by the service of a GSDP is structured as a sequence of one or more synchronisation steps. Each synchronisation step is divided into three parts as follows. The first part, known as the notification part, is responsible for sending messages relating to the synchronisation step to other processes. The second part, known as the listening part, is responsible for receiving and storing the messages that have been sent by other processes. The final part, known as the synchronisation part, is the core of the synchronisation step and has two main functions: (1) to detect that the synchronisation condition holds; and (2) to terminate the synchronisation step.

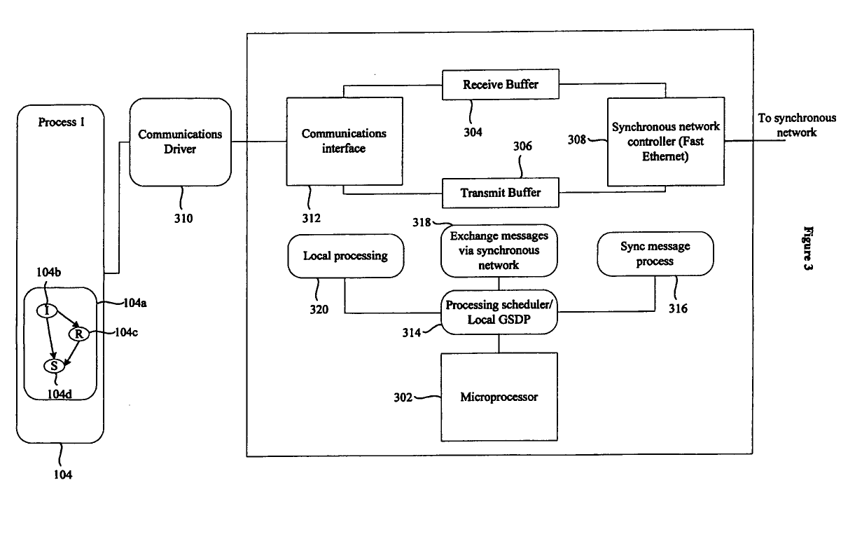

For each synchronisation step, each process has an associated state machine having, preferably, three states, which are an initial state, a synchronisation state and a final state described hereafter with reference to FIG. 3. In certain embodiments, the synchronisation state is also the final state. State transitions of the state machine are triggered by events reflected in the GSDs that each process receives by querying a local module of the GSDP. One skilled in the art appreciates that the GSDP is a distributed service that is realised using a collection of local GSDPs; one for each process executing the distributed algorithm. A process has access to the GSDP service by querying its local GSDP module. It will be appreciated by those skilled in the art that all processes start execution with their corresponding state machines being in their initial state. Whenever a process is delivered an SC-GSD, which is guaranteed by the synchronisation property of the GSDP, the process moves to the synchronisation state. Furthermore, due to the agreement property of the GSDP, correct processes act consistently in this state. Finally, upon being delivered a TC-GSD, which is guaranteed by the ordered delivery and the step termination properties of the GSDP, the processes move to the final state and finish the execution of the synchronisation step.

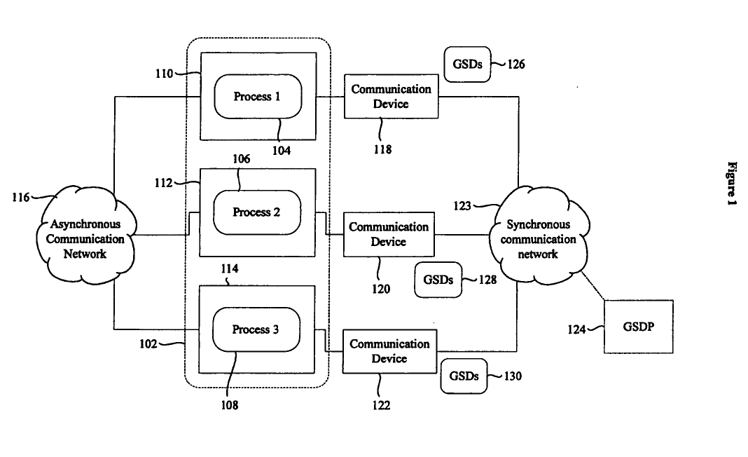

Referring to FIG. 1, there is shown a distributed computing system 100 according to an embodiment of the present invention. The distributed computing system is arranged to implement a distributed algorithm 102 via a number of processes 104, 106 and 108 executing at respective nodes 110, 112 and 114. It will be appreciated that the respective nodes comprise, typically, one or more computers. Also, it will be appreciated by those skilled in the art that the distributed algorithm 102 has been shown for the purpose of illustration as comprising three processes. However, a different number of processes can be used. Similar comments apply in relation to the number of nodes used in the distributed computing system 100.

Each of the nodes 110, 112 and 114 can communicate via an asynchronous or synchronous communication network 116. The communication network 116 can be implemented using any form of communication protocol and network interface (not shown).

As mentioned above it is necessary to augment the asynchronous system with a synchronous subsystem that is used to support the implementation of a GSDP. Therefore, the distributed processing system 100 comprises a number of communication devices 118, 120 and 122 to form such a synchronous subsystem. The synchronous subsystem is used to provide so-called wormholes via which the processes can communicate or via which they can be provided with or access, that is, request and/or receive, information relating to other processes. The synchronous subsystem, in particular, ensures that bounded messages are exchanged within bounded timescales. One of the communication devices is designated as a lead communication device for providing synchronisation data to each of the other communication devices to allow them to operate in a synchronous manner. For example, the first communication device 118 can be the lead communication device.

It can be appreciated that the communication devices 118, 120 and 122 communicate via a synchronous network 123. In preferred embodiments, the synchronous communication network 123 is implemented using a Fast Ethernet.

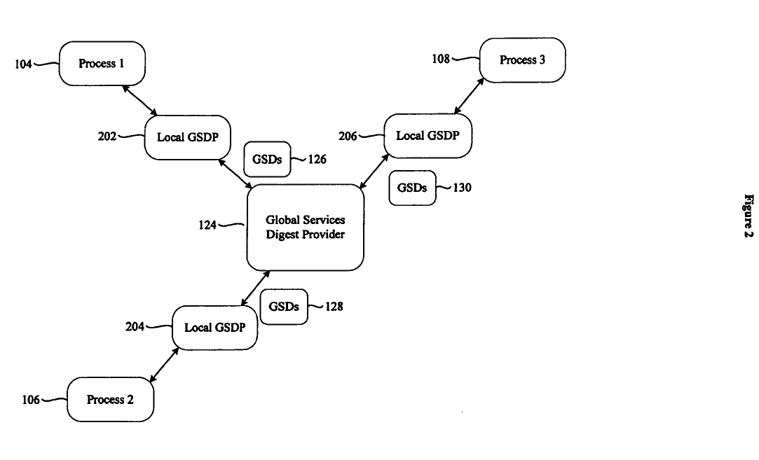

Referring to FIG. 2 there is shown a schematic representation of the interactions between the processes 104, 106 and 108 and a Global State Digest Provider 124. It can be appreciated that each of the processes interacts via a respective local global state digests provider 200, 204 and 206. It will be appreciated that the local global state digest providers ensure that they have an up to date indication of the state of the processes constituting the distributed algorithm and provide that indication to respective processes via the GSDs. It can be appreciated that the global state digests 126, 128 and 130 are stored by the local GSDPs 202, 204 and 206 for subsequent forwarding to their respective processes. It can be appreciated that the local GSDPs 202, 204 and 206 constitute a realisation of the conceptual Global Services Digest Provider 124.

FIG. 3 shows a schematic representation of a communication device 300 according to an embodiment of the present invention. Each of the communication devices 118, 120 and 122 is constructed in substantially the same manner as the illustrated communication device 300. It can be appreciated that the communication device 300 comprises a microcontroller 302. The microcontroller 302 is one of the Texas MPS 430 family of microcontrollers. In preferred embodiments, the microcontroller has an 8 MHz clock together with 2 KB of RAM and 60 KB of flash memory (not shown). The communication device 300 comprises a pair of buffers, that is, a receive buffer 304 and a transmit buffer 306. The receive buffer 304 is used to receive messages from the synchronous network 123 via a synchronous network controller 308. The transmit buffer 306 is used to store messages to be transmitted or output to the synchronous network 123 via the synchronous network controller 308. In preferred embodiments, the synchronous network controller 308 is a Fast Ethernet controller. However, one skilled in the art appreciates that other network controllers could equally well be used providing they can support the minimal synchrony guarantees required of the synchronous subsystem, that is, providing they can deliver the bounded messages within bounded timescales. The transmit buffer 306 is used for storing state information associated with a corresponding process. It can be appreciated that a first process 104 has been illustrated. A process, such as the first process 104, communicates with the communication device 300 via a communications driver 310 and a communications interface 312, which forms part of the communication device 300. The communication interface 312 can be any form of interface that supports synchronous or asynchronous communications. It can be appreciated that the synchronization step executed by process 104 comprises a state machine 104a that reflects the current state of the process. The state machine 104a, in preferred embodiments, has three states, which are an initial state 104b, a synchronisation state 104c and a final state 104d, which are used to reflect the current state of a process while executing a synchronisation step.

The communication device 300 is arranged to operate in a time slot, that is, Time Division Multiple Access mode or preemptive multitasking mode, in which a processing scheduler 314 manages the resources, that is, the microcontroller and associated hardware, of the communication device to divide operations of the communication device into three distinct periods or time slots. The lead communication device uses a first time slot of the three time slots to distribute a synchronisation message. The synchronisation message need not comprise any particular data. It is sufficient if the device has received a message in that time slot. It will be appreciated that synchronisation can be achieved using the time of receipt of the message since communications via the wormhole are bounded. In effect, the synchronisation message is used to implement a synchronised global clock see, for example, “An overview of clock synchronization”, Lecutre Notes In Computer Science, Fault-tolerant Distributed Computing, pp. 84-96, 1990, B. Simons, J. L. Welch, N. Lynch. It can be appreciated that the processing scheduler 314 invokes a synchronisation message process 316 to achieve this end. The second time slot is a time slot in which messages are exchanged with the other processes of the distributed algorithm. It will be appreciated that the GSDs used by embodiments of the present invention are received during the second time slot. Furthermore, state information relating to a local process is output, that is, transmitted, during the second time slot. It can be appreciated that the processing scheduler 314 invokes an exchange messages process 318 to achieve the above.

During the third time slot, each communication device undertakes local processing such as, for example, communication with the asynchronous local node. It can be appreciated that the processing scheduler 314 invokes a local processing process 320 to manage communications with the process running a respective local node.

The communication interface 312 and the communications driver 310, as mentioned above, form an interface between the synchronous subsystem and the asynchronous system or asynchronous node. In preferred embodiments, this interface requires (1) the synchronous subsystem to be capable of handling asynchronous requests issued by respective process of the asynchronous node; and (2) the responses of the synchronous subsystem to be consumed by the asynchronous node without requiring an unbounded memory. Embodiments of the present invention address the first requirement as follows. As can be appreciated from the above, the synchronous subsystem is based on a microcontroller 302 that is capable of having its interrupts disabled. Therefore, that microcontroller 302 is arranged so that its interrupts are disabled, which ensures that its attention or, more accurately, the resources of the communication device 300, is only directed to the asynchronous node when the processing scheduler 314 determines that that should be the case, that is, during the third time slot. It can be appreciated that this arrangement limits the time window during which the asynchronous and the synchronous systems can interact. Unfortunately, the second requirement cannot be truly met. Indeed, as will be appreciated by one skilled in the art, without assumptions on processing speeds, it is thought to be impossible to guarantee that an asynchronous system will consume all information that is periodically generated by the synchronous subsystem. However, the properties of the GSDP are guaranteed even if some GDSs are lost. This follows as a consequence of the state information stored within a GDS being monotonic, that is, the notion of monotonicity, which is that every SC-GSD and TC-GSD carry the same information relating to how a synchronisation step must finish; since a TC-GSD is eventually delivered to the asynchronous system, then all correct processes finish all synchronisation steps in a consistent way, is used to meet or at least attempt to meet or compensate for the second requirement

Each process executing part of the distributed algorithm supported by the GSDP is structured as a sequence of synchronisation steps. It will be appreciated by those skilled in the art that most distributed algorithms can be structured in such a manner. Each synchronisation step is described in further detail below.

Although the above embodiment has been described with reference to one of the communication devices also functioning as a GSDP, embodiments of the present invention are not limited to such an arrangement. Embodiments can be realised in which the GSDP is implemented as a separate entity connected to the synchronous communication network 110. Such a GSDP 124 has also been illustrated in FIG. 1. It will be appreciated that such a GSDP 124 will assume the responsibilities formerly undertaken by the lead communication device 118. Optionally, under such circumstances, the lead communication device 118 can assume the role of a standby or deputy Global State Digest Provider.

The function of the GSDP 118 (or 124) is to collate state information (not shown) associated with the states of the processes 104 106 and 108 to form a global state digest for each of the processes. As indicated above the GSDP 118 is used to provide each of the processes with an ordered sequence of GSDs 126, 128 and 130. The GSDs are used to influence the execution of the processes 104 106 and 108 as described above, that is, in the performance of the synchronisation steps associated with the processes.

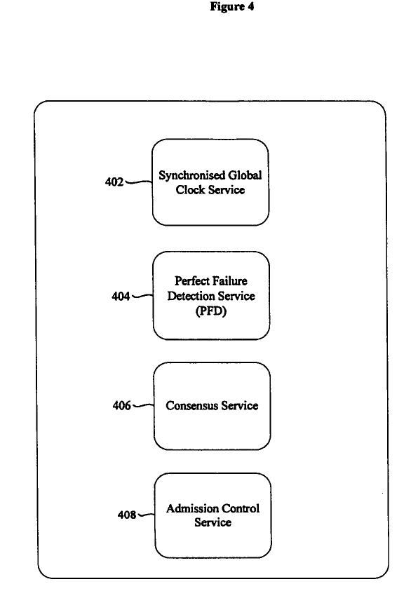

Referring to FIG. 4 there is shown a schematic representation 400 of the services provided by a Global State Digest Provider (local GSDP) such as, for example, lead communication device 118 or GSDP 124. It will be appreciated that the services provided by the GSDP are in practice services provided by each of the local GSDPs. However, for convenience, the services are being described as being provided by a “central” GSDP. The Global State Digest Provider 400 presents an Application Programming Interface (API) for making the following four basic services available. These four basic services provide the infrastructure to implement more complex services. The GSDP 400 comprises a synchronised global clock service 402 to allow the communication devices 118, 120 and 122 to operate synchronously. In preferred embodiments, a portion of the bandwidth of the synchronous subsystem, that is, the Wormhole bandwidth, is reserved or allocated to the implementation of a global synchronised clock. This allows, for example, applications using a failure detector to know when, according to the time indicated by this clock, a node was not suspected by any other node. The GSDP 400 comprises a Perfect Failure Detection Service (PFD) 404 to detect failures of nodes and to guarantee an upper bound on detection latency in the detection of a failure. The PFD 404 also requires a portion of the wormhole bandwidth to be reserved for its function. Applications can query the failure detector to identify nodes that have crashed. The GSDP 400 comprises, in preferred embodiments, a Consensus Service 406 that disseminates messages throughout the asynchronous network and that uses the PFD service 404 to obtain a consensus. It can be appreciated that the service does not use the Wormhole bandwidth. It will be appreciated that this is advantageous since the bandwidth within a wormhole is limited. Therefore, not all messages of the algorithm can be sent via the synchronous system, particularly application messages whose size is unknown a priori. The final service provided by the GSDP 400 is an Admission Control Service 408 since, in practice, synchronism can only be achieved through control access.

The basic services illustrated can be used as the basis for defining a set of secondary services, which execute, as indicated above, on a time slot basis using three time slots to (a) receive messages, (b) perform some local processing, preferably, according to the messages received and (c) transmit messages. Therefore, in response to invocation or establishment of a secondary service, the communication device 300 (a) establishes an input buffer for storing received messages, (b) invokes or establishes a function that will be executed periodically to process the messages received and prepares the messages to be sent and (c) establishes a transmit buffer in which the communication device will collate messages to be transmitted within bounded delays to other communication devices within the distributed system.

An API for accessing the above-described basic services is as follows:

Perfect Failure Detection Service:

ip_list→get-corrects( ), queries the failure detector for correct nodes and provides a list of IP addresses of the nodes that are not currently suspected.

correct→is_correct( ), which verifies that a specified IP address corresponds to one of the nodes known to be correct.

Synchronisation Global Clock

current_time→get_global_time( ), which reads the globally synchronised clock;

Basic Consensus Service

propose(value), which informs the other processes or nodes of a value to be proposed;

finished→is_decided( ), which determines if a consensus has already been achieved;

value→get_decision( ), which retrieves the decided value according to consensus decision rules.

Admission Control

service_available→request_service(service_name,duration_time,service_parameters), which requests the use of an available service; the parameters are the name of the service, an indication of how long the service will be required and a structure comprising service specific parameters. It will be appreciated that the result will be the access to the service. If the request is denied, the requester will be notified of the reason for denial.

The above basic services can be used to realise embodiments of the following secondary services that support distributed algorithms according to embodiments of the present invention.

Process Level Failure Detection

monitor(process), which starts monitoring a process,

unmonitor(process), which stops the monitoring of a process,

process_state→is_correct(process), which determines whether or not a process is correct and returns an indication of the state of that process, that is, indicates if the process if correct or not,

process_list→get_corrects( ), which queries the failure detector to identify correct processes that are being monitored.

Global State Digest Provider

broadcast_state(state), which broadcasts a process's or node's local state,

global→get_global_state( ) or global→getGSD( ), which provide an indication of a consistent global state, that is, an ordered list of GSDs.

Although embodiments of the present invention have been described with the above API, they are not limited to such an arrangement. Embodiments can be realised that provide or use a different API. For example, admission control is preferred in embodiments support dynamic service loading, that is, support services loaded on-the-fly. A simpler embodiment can be realised in which all required services are built into the hybrid system a priori.

Designing Consensus Protocol Supported by a Global State Digest Provider

There will now be described a pair of embodiments of the present invention with reference to addressing a common or fundamental problem within distributed systems, which is reaching a consensus among a set of n processes that communicate exclusively by the exchange of messages within the distributed system. In this problem, each process pᵢ proposes a value vᵢ and every correct process must decide for the same common value v despite the possible crashes of up to f processes, where f<n. The following liveliness and safety properties must be guaranteed by any solution to the consensus problem: every correct process eventually decides upon some value (termination); every process decides at most once (uniform integrity); if a process decides for the value v, then v was proposed by some process (uniform validity); and, no two processes decide differently (uniform agreement). Further information on the consensus problem is available from, for example, M. J. Fischer, “The Consensus Problem in Unreliable Distributed Systems”, Research Report 273, Yale University, June 1983, which is incorporated herein by reference for all purposes.

It will be appreciated that both protocols are structured as a single synchronisation step.

A very Simple Consensus Algorithm

According to this embodiment, suitable representations for a GSD, a SC-GSD and a TC-GSD are defined as follows. A possible GSD to solve the consensus problem is formed by a vector of n bits, named GSD.status, an n×n matrix of bits, named GSD.reception and a write-once integer, named GSD.consensuslId. Any given bit, k, of the GSD.status vector, that is, GSD.status[k], is set to zero only if the crash of pₖ has been detected. The element GSD.reception[i,j] is set to 1 only if pᵢ has received a message from pⱼ during the execution of the synchronisation step, otherwise it is set to 0. For the consensus problem, the synchronisation condition describes a state that allows a safe decision to be made. The simplest synchronisation condition that allows such a decision is: there is a message that has been received by all processes that have not crashed, preferably in conjunction with some deterministic function to break ties when there is more than one qualifying message, that is, more than one message that has been received by all correct processes. GSD.consensualId is initialised to a ‘null’ value and set to the identity of the process that has broadcast the qualifying message in the first time that the above condition holds. Since GSD.consensualId is a write-once variable, all future GSDs generated for this particular execution of the consensus will carry the same value for GSD.consensualId. Similarly, a suitable definition of a termination condition is required for a process pᵢ; this condition describes a state that allows pᵢ to infer that all other processes are able to terminate their execution of the synchronisation step without any help from pᵢ despite the possible crashes of the other processes. For this simple consensus algorithm the synchronisation condition is also a termination condition, since after reaching a synchronisation condition, a process pᵢ knows that every other correct process will also reach the same synchronisation condition; further, pᵢ also knows that the decision message has been received by every correct process, that can therefore decide and terminate their synchronisation step. This is to say that, for this algorithm, any SC-GSD is itself a TC-GSD.

The actions that must be taken by the three parts comprising the synchronisation step should then be defined. The notification part can be implemented in any one of several ways. The simplest implementation, but not necessarily the most appropriate, is for every process to broadcast its value to all other processes. In such an embodiment, the listening part is also very simple. The listening part loops until a decision is reached, receiving messages sent from the other processes and storing them in the receive buffer 304, that is preferably implemented using a shared buffer structure, bagOfMessages, as will be appreciated from the pseudocode below. The synchronisation part works as follows. It repeatedly queries the local module of the GSDP. As soon as a SC-GSD is delivered, the message that has been sent by the process whose identity is indicated by, or correspond to, the consensualId field of the SC-GSD is retrieved from the local buffer of the process and the process decides for the value that this message contains. After the decision has been made, the process terminates execution of the synchronisation step. Algorithm one below represents the pseudocode of concurrent threads that implement this algorithm while FIG. 5 shows the state transitions of the state machine for the synchronisation part of the synchronisation step.

Referring to FIG. 5, there is shown a state transition diagram 500 of the transitions undertaken by the state machine of the processes involved in implementing the simple consensus algorithm shown in algorithm 1. All processes are, upon initialisation, arranged so that their corresponding state machine is in an initial state 502. Upon the process determining that there is at least one process within a received GSD such that the message it has broadcast has been received by all correct processes a state transition 504 occurs to move the state machine from the initial state 502 to a synchronisation and final state 506.

Algorithm 1: The pseudo-code of a very simple
consensus algorithm executed by process pᵢ
/* variables shared by all tasks */
bagOfMessages={}
decided=false
Task notification
send vᵢ to all processes
Task listening
while !decided do

when receive vⱼ from pⱼ

add vⱼ to bagOfMessages
notify the local GSDP module that pⱼ's message has
been received

end when

end while
Task synchronisation
while !decided do

GSD=getGSD( )
if isSynchronisationCondition(GSD) then

m=getConsensusMessage(GSD, bagOfMessages)
decided=true
decide(m.getValue( ))

end if

end while

The function getGSD( ) is used to obtain an ordered list of GSDs from a local GSDP. The function isSynchronisationCondition(GSD) is used to determine from the ordered list of GSDs previously obtained whether or not the synchronisation condition has been satisfied. The function getConsensusMessage(GSD,bagOfMessages) is used to extract consensus information, that is, the consensus message from the buffer storing the received messages, that is, from the buffer defined by bagOfMessages using the first SC-GSD received. The message has a structure that includes a function, getValue( ), extracting the consensually agreed value. The function decide(m.getValue) is used to provide an indication of that agreed value.

Lemma 1. The GSDs used in the algorithm presented in the embodiment represented by Algorithm 1 are well formed.

Proof. Since the channels are reliable and every process broadcasts its value to all processes, at least n-f messages will be received by all correct processes. After some message is received by all correct processes, the GSDs formed are SC-GSDs, thus synchronisation is satisfied. Since, for the GSD defined, every SC-GSD is also a TC-GSD, the termination and ordered formation properties are also satisfied. Further, after one TC-GSD is formed, every subsequent GSD also indicates that all correct processes have received the consensual message. It may be the case that the GSDs contain fewer correct processes, if some processes crash after the SC-GSD is formed, nevertheless, in both cases all future GSDs are also TC-GSDs and, therefore, the monotonicity property is also satisfied.

Theorem 1. The algorithm presented in Algorithm 1 solves the consensus problem.

Proof. Most of the properties of the GSDP are only guaranteed if the GSDs defined are well formed. From lemma 1, this is guaranteed. The termination property of consensus is guaranteed by the step termination property of the GSDP. There is just one decision point in the algorithm and after deciding the process finishes its execution, thus the uniform integrity of the consensus is also satisfied. The values proposed by the processes are sent in broadcast messages and then one of them is used as the decision value, thus guaranteeing uniform validity. Finally, the agreement property of the GSDP guarantees that the uniform agreement property of the consensus is satisfied.

Message Efficient Consensus Algorithm

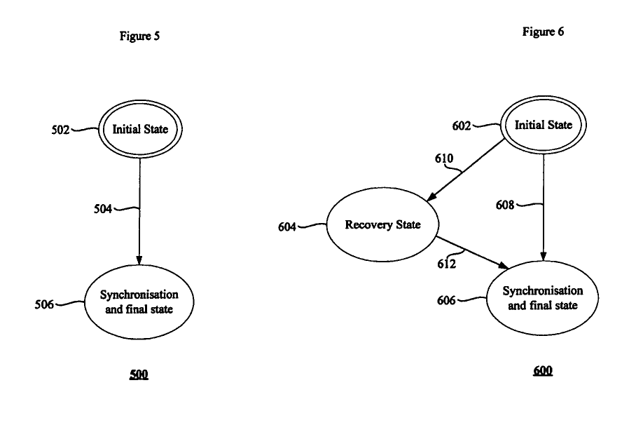

A message efficient consensus algorithm uses the same data structure for the GSDs as the previously presented algorithm. The message efficient consensus algorithm requires only small modifications to the notification and synchronisation parts of the previous algorithm. In the notification part, not all processes are required to broadcast a message. It will be appreciated, therefore, that this embodiment reduces the amount of message traffic required to implement the algorithm. In a manner that is substantially similar to the algorithm presented in Marcos K. Aguilera, Gérard Le Lann and Sam Toueg, “On the Impact of Fast Failure Detectors in Real-Time Fault-Tolerant Systems”, 16 International Symposium on Distributed Computing, pages 354-369, October 2002, which is incorporated herein by reference for all purposes, a process only broadcasts a message if all processes with a smaller identification have crashed. To monitor the status of the other processes, a process queries a local variable that is updated by the synchronisation part of the step. The only modification required in the synchronisation part of the step is the maintenance of such a variable. Algorithm 2 is the pseudocode of the concurrent threads that implement the algorithm, while FIG. 6 illustrates the state transitions of the state machines for the embodiment described. Referring to FIG. 6 there is shown a state transition diagram 600 of the transitions undertaken by the state machines of the processes involved in implementing the message efficient consensus algorithm shown in algorithm 2. FIG. 6 depicts a state transition diagram 600 comprising an initial state 602, a recovery state 604 and a synchronisation and final state 606. A state transition 608 occurs between the initial state 602 and the synchronisation and final state 606, as indicated above with reference to FIG. 5, when the process determines from the GSD that at least one process identified in the GSD is such that the message it broadcast has been received by all correct processes. A state transition 610 occurs between the initial state 602 and the recovery state 604 when the process determines that all other processes having a smaller process ID have crashed. A state transition 612 occurs between the recovery state 604 and the synchronisation and final state 606 when it is determined from the GSD that at least one process identified in the GSD is such that the message it broadcast has been received by all correct processes.

Algorithm 2: The pseudo-code of a message efficient
consensus protocol executed by process
pᵢ
/* variables shared by all tasks */
bagOfMessages={}
decided=false
Task notification
If i=1 then

send vᵢ to all processes

end if
Task listening
while !decided do

when receive vⱼ from pⱼ

add vⱼ to bagOfMessages
notify the local GSDP module that pⱼ's message has
been received

end when

end while
Task synchronisation
while !decided do

GSD=getGSD( )
if isSynchronisationCondition(GSD) then

m=getConsensusMessage(GSD, bagOfMessages)
decided=true
decide(m.getValue( ))

else

if ∀j, j<i, GSD.status[j]=0 then

send vᵢ to all processes

end if

end if

end while

Lemma 2. The GSDs used in the protocol presented in Algorithm 2 are well formed.

Proof. The notification part of the protocol and the strong accuracy property of the GSDP guarantee that one correct process eventually broadcasts its message, thus since the channels are reliable at least this message will be received by all correct processes (note that crashed processes may have crashed after broadcasting their messages, thus, these messages can also be received by all processes). After all correct processes receive any of these messages, the GSDs formed are SC-GSDs and, therefore, synchronisation is satisfied. Since for the GSD defined, every SC-GSD is also a TC-GSD, the termination and ordered formation properties are also satisfied. Further, after one TC-GSD is formed, every subsequent GSD also indicates that all correct processes have received the consensual message. It may be the case that the GSDs contain fewer correct processes, if some processes crash after the SC-GSD is formed, nevertheless, in both cases all future GSDs are also TC-GSDs and, therefore, the monotonicity property is also satisfied.

Theorem 2. The protocol presented in Algorithm 2 solves the consensus problem.

Proof. From lemma 2, the GSDs are well formed. The termination property of consensus is guaranteed by the step termination property of the GSDP. There is just one decision point in the algorithm and after deciding the process finishes its execution, thus the uniform integrity of the consensus is also satisfied. The values proposed by the processes are sent in broadcast messages and then one of them is used as the decision value, thus guaranteeing uniform validity. Finally, the agreement property of the GSDP guarantees that the uniform agreement property of the consensus is satisfied.

Although the embodiments of the present invention have been described with reference to implementing simple and message efficient consensus algorithms, embodiments are not limited thereto. Embodiments can be realised, for example, by considering that f_{actual}, f_{actual}<f, processes have already crashed. In such embodiments, a possible termination condition is: is there a message that has been received by at least f+1−f_{actual} processes plus, preferably, a deterministic function to break ties when there is more than one qualifying message? In such an embodiment, the synchronisation condition can be implemented as follows: if the consensual message is already in the buffer of received messages, then the process distributes the message to all correct processes that have not yet received the message and the process decides for the value contained in the message; otherwise a process waits for the consensual message to enter the buffer of received messages and decides for the value that it contains.

The reader's attention is directed to all papers and documents that are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A synchronous communication system, for use in an asynchronous or hybrid distributed system for executing a distributed algorithm, the system comprising a plurality of processing nodes each running a respective process associated with the distributed algorithm; and a synchronous communication system for exchanging bounded messages between selected processes within bounded time periods; the synchronous communication system comprising means to obtain global digest data comprising an indication of events associated with each, or selected, processors of the plurality of processes during a particular time interval.

2. A system as claimed in claim 1 in which the means to obtain the global digest data comprises means to obtain global digest data relating to a number of processes of the plurality of processes.

3. A system as claimed in claim 1 in which the means to obtain global digest data comprises means to obtain the global digest relating to all correct processes of the plurality of processes.

4. A system as claimed in claim 1 comprising means to obtain a plurality of global digest data, each global digest data relating to a respective process of at least some of the plurality of processes.

5. A system as claimed in claim 1 in which the global digests data has a type corresponding to at least one of a synchronisation global digest data and a termination global digest data.

6. A system as claimed in claim 1 in which the global digest data comprises an indication of the operational status of the plurality of processes.

7. A system as claimed in as claimed in claim 6 in which the global digest data can comprise an indication of at least one of those other processors of the plurality of processes that have crashed and those other processors of the plurality of processes that have not crashed.

8. A system as claimed in claim 1 in which the GSD comprises a detection vector having at least one data unit per process of the plurality of processes; each of the data units providing an indication of the operational status of a respective process.

9. A system as claimed in claim 1 in which the GSD comprises a reception matrix comprising an indication of communication exchanges between the plurality of processes.

10. A system as claimed in claim 9 in which the reception matrix is an n×n in which an element [i,j] represents a perception of a first process, pᵢ, of the processing of a second process, pⱼ.

11. A system as claimed in claim 1 in which the global digest data comprises an ordered set of a number of global digest data.

12. A system as claimed in claim 1 in which the global digest data is well formed.

13. A system as claimed in claim 12 in which the global digest data is such that, for every execution of a synchronisation step, it comprises all of the following properties:
Synchronisation in which at least one SC-GSD is formed such that this property guarantees that all correct processes of the plurality of processes will reach a point in the execution of the algorithm step such that the outcome of the step is known;
Termination in which at least one TC-GSD is formed for every process of the plurality of processes that does not crash before or during the execution of the step, which guarantees that all correct processes of the plurality of processes finish the execution of an algorithm step and are able to proceed to the next step, if there is such a step;
Ordered formation in which no TC-GSD can be formed before a SC-GSD is formed; and
Monotonicity in which if a TC-GSD is formed for a process, pᵢ, then every subsequent GSD formed is also a TC-GSD for pi.

14. A system as claimed in claim 1 in which the size of the GSD is bounded.

15. A system as claimed in claim 1 in which each of the plurality of processes comprises a respective state machine.

16. A system as claimed in claim 15 in which the state machine comprises at least one of an initial state, a recovery state, a synchronisation and final state.

17. A system as claimed in claim 16 in which a transition from the initial state to the synchronisation and final state occurs if it is determined that the GSD comprises an indication of at least one process of the plurality of processes such that the broadcast message associated with that at least one process has been received by a number of processes of the plurality of processes.

18. A system as claimed in claim 17 in which the number of processes of the plurality of processes comprises all correct processes of the plurality of processes.

19. A system as claimed in claim 16 in which a transition from the initial state to the recovery state occurs if it is determined from the GSD that predeterminable processes of the plurality of processes have an associated operational condition.

20. A system as claimed in claim 19 in which the associated operational condition is a crashed state.

21. A system as claimed in claim 19 in which the predeterminable processes of the plurality of processes are those other processes with corresponding process identification data having a predetermined relationship with identification data of a current process.

22. A system as claimed in claim 21 in which the predeterminable processes of the plurality of processes are those processes having a smaller ID as compared to the ID of the current process.

23. A system as claimed in claim 1 in which the algorithm comprises a predeterminable operational structure.

24. A system as claimed in claim 23 in which the predeterminable operational structure comprises at least one of, and preferably all of, a notification part, a listening part and a synchronisation part.

25. A system as claimed in claim 24 in which the notification part comprises means to send messages relating to a synchronisation step of an associated process to at least selectable processes of the plurality of processes.

26. A system as claimed in claim 24 in which the listening part comprises means for exchanging messages between an associated process and at least selectable processes of the plurality of processes.

27. A system as claimed in claim 24 in which the synchronisation part comprises a detector to detect a prevailing synchronisation condition and means to terminate a synchronisation step of an associated process.

28. A system as claimed in claim 1 in which the synchronous communication system comprises a time division processing arrangement providing substantially contiguous operational time slots.

29. A system as claimed in claim 28 in which the time division processing arrangement comprises a scheduler operable to provide substantially contiguous operational time slots arranged according to a repeating pattern.

30. A system as claimed in claim 29 in which the scheduler comprises means operable such that repeating pattern comprises first, second and third time slots.

31. A system as claimed in claim 30 in which the scheduler is operable such that the first time slot is utilised to provide a globally synchronised clock to the plurality of processes.

32. A system as claimed in claim 30 in which the scheduler is operable such that the second time slot is utilised to exchange messages between the plurality of processes.

33. A system as claimed in claim 30 in which the scheduler is operable such that the third time slot is utilised by the plurality of processes to perform local processing operations.

34. A synchronous system for use in an asynchronous distributed system for executing a distributed algorithm, comprising a scheduler for exchanging communication messages with a process forming part of the algorithm executable by an asynchronous subsystem of the asynchronous distributed system according to a time division arrangement.

35. A synchronous system as claimed in claim 34 further comprising means to receive at least one message from at least one other process of the distributed algorithm; the received message being associated with a monotonicity condition.

36. A synchronous system as claimed in claim 35 in which the monotonicity condition is if a TC-GSD is formed for a process pᵢ, then every subsequent GSD formed is also a TC-GSD for pᵢ.

37. A computer program comprising computer executable code means to implement a system as claimed in claim 1.
